(19) United States
(12) Patent Application Publication
(10) Pub. No.: US 2026/0152147 A1
(43) Pub. Date: Jun. 4, 2026

(54) VEHICLE EMBLEM ASSEMBLY WITH PLUGGABLE INTERNAL MODULE

(71) Applicant: Ford Global Technologies, LLC, Dearborn, MI (US)

(72) Inventors: Hans Hoffmann, Frechen (DE); Dirk Kusche, Düsseldorf (DE)

(21) Appl. No.: 19/396,467

(22) Filed: Nov. 21, 2025

(30) Foreign Application Priority Data
Dec. 4, 2024 (DE) 102024136036.4

(51) Int. Cl. B60R 25/31; B60Q 1/50; B60R 25/01

(52) U.S. Cl. CPC B60R 25/31; B60Q 1/503; B60R 25/01

(57) ABSTRACT

An emblem assembly for a motor vehicle may include an emblem module configured to be arranged on an outside of an external paneling element of the motor vehicle. The emblem module may include at least one electrically activatable functional unit and at least one emblem connector. The assembly may also include an internal module configured to be arranged on an inside of the external paneling element. The internal module may include an electrically activatable internal module unit and at least one inner connector. The at least one inner connector and the at least one emblem connector may form a connector pair. At least a portion of the connector pair may be configured extend through a through-opening in the external paneling element such that the emblem assembly is securable on the external paneling element and the internal module unit is electrically connectable to the at least one functional unit.

### RELATED APPLICATION(S)

This disclosure claims priority to German Patent Application No. 102024136036.4, filed Dec. 4, 2024, the entirety of which is herein incorporated by reference.

### TECHNICAL FIELD

The disclosure relates to motor vehicles, and in particular to emblem assemblies for motor vehicles.

### BACKGROUND

Motor vehicles have external emblems for identification. Emblems may include signs, characters, or combinations thereof to identify the vehicle manufacturer or model. Such emblems are positioned on external panels, including closure panels like cargo compartment lids.

### SUMMARY

In some aspects, the techniques described herein relate to an emblem assembly, including: an emblem module configured to be arranged on an outside of an external paneling element of a motor vehicle, wherein the emblem module includes at least one electrically activatable functional unit and at least one emblem connector; and an internal module configured to be arranged on an inside of the external paneling element, wherein the internal module includes an electrically activatable internal module unit and at least one inner connector, wherein the at least one inner connector and the at least one emblem connector form a connector pair, wherein at least a portion of the connector pair is configured extend through a through-opening in the external paneling element such that the emblem assembly is securable on the external paneling element and the internal module unit is electrically connectable to the at least one functional unit.

In some aspects, the techniques described herein relate to an emblem assembly, wherein the internal module unit is configured for control of the at least one functional unit.

In some aspects, the techniques described herein relate to an emblem assembly, wherein the internal module unit is configured for signal processing of the at least one functional unit.

In some aspects, the techniques described herein relate to an emblem assembly, further including at least one additional connector pair.

In some aspects, the techniques described herein relate to an emblem assembly, wherein the at least one emblem connector and the at least one inner connector of the connector pair have electrical contacts via which the internal module unit and the at least one functional unit are conductively connectable.

In some aspects, the techniques described herein relate to an emblem assembly, wherein one of the at least one emblem connector and the at least one inner connector has an elastically deflectable latching element which engages in a recess on the other of the at least one emblem connector and the at least one inner connector.

In some aspects, the techniques described herein relate to an emblem assembly, wherein the at least one emblem connector protrudes from the emblem module and is configured to protrude through the through-opening.

In some aspects, the techniques described herein relate to an emblem assembly, wherein the at least one functional unit has at least one light element configured to at least partially illuminate the emblem module.

In some aspects, the techniques described herein relate to an emblem assembly, wherein the at least one functional unit is a sensor unit triggerable by a user.

In some aspects, the techniques described herein relate to an emblem assembly, wherein the sensor unit is a capacitive sensor.

In some aspects, the techniques described herein relate to a motor vehicle, including: an external paneling element; and an emblem assembly including: an emblem module having an emblem module body arranged on an outside of the external paneling element, at least one electrically activatable functional unit, and at least one emblem connector; and an internal module having an internal module body arranged on an inside of the external paneling element, an electrically activatable internal module unit, and at least one inner connector which together with the at least one emblem connector forms a connector pair, wherein at least one connector of the connector pair protrudes from an associated one of the emblem module body and the internal module body, wherein the connector pair is plugged together through a through-opening in the external paneling element such that the emblem assembly is secured on the external paneling element and the internal module unit is electrically connected to the at least one functional unit.

In some aspects, the techniques described herein relate to a motor vehicle, wherein the at least one functional unit has at least one light element configured to at least partially illuminate the emblem module.

In some aspects, the techniques described herein relate to a motor vehicle, wherein the at least one functional unit is a sensor unit triggerable by a body part of a user.

In some aspects, the techniques described herein relate to a motor vehicle, wherein the sensor unit is a capacitive sensor.

In some aspects, the techniques described herein relate to a motor vehicle, further including a closure element, wherein the closure element is unlockable by triggering the sensor unit.

In some aspects, the techniques described herein relate to a motor vehicle, wherein the closure element is a cargo compartment lid.

In some aspects, the techniques described herein relate to a method, including: plugging a connector pair of an emblem assembly together through a through-opening in an external paneling element of a motor vehicle, wherein the connector pair includes at least one emblem connector of an emblem module and at least one inner connector of an internal module, wherein the plugging is such that the emblem assembly is secured in a positive-locking manner on the external paneling element and an electrically activatable internal module unit of the internal module is electrically connected to at least one electrically activatable functional unit of the emblem module.

In some aspects, the techniques described herein relate to a method, further including: controlling at least one light element to illuminate the emblem module at least in sections.

In some aspects, the techniques described herein relate to a method, further including: detecting, via a sensor unit, a body part of a user in proximity to the emblem module.

In some aspects, the techniques described herein relate to a method, further including: unlocking a closure element of the motor vehicle in response to detecting the body part of the user.

### BRIEF DESCRIPTION OF THE DRAWINGS

FIG. 1 illustrates a perspective view of a motor vehicle with an example vehicle system.

FIG. 2 illustrates a schematic sectional view of a portion of the motor vehicle with an emblem assembly in an initial assembly phase.

FIG. 3 illustrates a schematic sectional view of the portions of the motor vehicle with the emblem assembly in a further assembly phase.

FIG. 4 illustrates a schematic sectional view of the portion of the motor vehicle with the emblem assembly in the assembled state.

### DETAILED DESCRIPTION

The disclosure relates to motor vehicles, and in particular to emblem assemblies for motor vehicles. This disclosure enables an emblem module to maintain a size comparable to conventional emblems while integrating additional functions. This disclosure further facilitates attachment without redesigning the external paneling element. Additionally, this disclosure allows use of existing through-openings for conventional emblem attachment in some variants, and positions some relatively sensitive components on the inner side to resist environmental influences.

It is to be noted that the features and measures explained individually in the description below can be combined with one another in any technically expedient manner and disclose further embodiments of the disclosure. The description further characterizes and specifies the disclosure, particularly in connection with the figures.

The disclosure provides a vehicle system for a motor vehicle. This disclosure is not limited to any particular type of motor vehicle. For example, the drive motor can be an internal combustion engine or an electric drive motor, or a combination in the form of a hybrid drive. Further, the motor vehicle can be a passenger vehicle, a lorry, or a bus, as examples. The motor vehicle can be controlled by a driver or autonomously. For the sake of brevity, the motor vehicle will also be referred to as “vehicle” in some instances below. The vehicle system has various electrical components, i.e. components that can be operated with electricity.

The vehicle system has an emblem assembly. The term “emblem” refers here and below to any type of sign used to identify a vehicle manufacturer or vehicle model. It may be a pictorial sign in particular, but it may also feature one or more characters, namely letters or numbers.

The emblem assembly has an emblem module with an emblem module body for arranging on the outside of an external paneling element of the motor vehicle, at least one electrically activatable functional unit, and at least one emblem connector part (or simply “connector”). The emblem module could also be referred to as an external module. It has an emblem module body that is designed to be arranged on the outside of an external paneling element. The external paneling element is part of the external paneling of the vehicle and has a surface that faces the environment of the vehicle. It can be made in a known manner for example from sheet metal or synthetic material, or possibly also fiber-reinforced synthetic material. Of course, it can also consist of a plurality of materials. The external paneling element can be regarded as part of the vehicle system. The external paneling element has an outer side facing the vehicle environment and an inner side facing the interior of the vehicle body, for example the passenger compartment, the engine compartment, the cargo compartment etc. In the assembled state, the emblem module body is located on the outer side. In an example, the emblem module body lies at least in part on the outside of the external paneling element. Its shape can be adapted to the shape of the external paneling element accordingly. On a side facing away from the external paneling element, the emblem module body may feature the above-mentioned emblem, which identifies the vehicle model and/or the manufacturer.

Furthermore, the emblem module has an electrically activatable functional unit. The functional unit is integrated into the emblem module body. The emblem module body may feature a housing made of electrically non-conductive material, for example made of synthetic material. The functional unit may be installed in this housing. Due to the presence of the functional unit, the emblem module is not merely a passive element that is used solely for identification but has at least one additional function. Types of additional functions will be further discussed below. The functional unit is electrically activatable, i.e. its function relates to electrical energy which is supplied to the functional unit. For activation purposes, a current can flow through the functional unit; however, a voltage could also be applied to the functional unit without a current flowing through. Furthermore, the emblem module has at least one emblem connector part. This could also be referred to simply as an emblem connector. However, here and below, terms such as “connector,” “connector part,” or similar refer to both male and female plug-in connectors, i.e. no distinction is made between plugs and sockets. As will be explained below, the at least one emblem connector part serves to establish both a mechanical connection and an electrical connection. Although the emblem connector part and the emblem module body are referred to separately here, embodiments are conceivable in which there is no clear distinction between these two elements. By way of example, in some embodiments, the emblem connector part may be at least in part integrated into the emblem module body. In particular, it may be manufactured at least in part as one piece with the emblem module body. By way of example, non-conductive areas of the emblem connector part may be manufactured as one piece with a part of the above-mentioned housing of the emblem module body. In an example, the emblem connector part is rigidly connected to the emblem module body.

In accordance with the disclosure, the emblem assembly has an internal module with an internal module body for arranging on the inside of the external paneling element, an electrically activatable internal module unit, and at least one inner connector part which together with an emblem connector part forms a connector pair, wherein at least one connector part protrudes from the associated module body, wherein the connector pair can be plugged together through a through-opening in the external paneling element, so that the emblem assembly is secured in a positive-locking manner on the external paneling element and the internal module unit is electrically connected to each functional unit.

In the assembled state, the internal module body is arranged on the inner side of the external paneling element and lies against it at least in some areas on the inside. Its shape can be adapted to the shape of the external paneling element accordingly. Furthermore, the internal module has an electrically activatable internal module unit. The internal module unit is integrated in the internal module body. The internal module body can have a housing that is made of an electrically non-conductive material, for example made of synthetic material. The internal module unit can be installed in this housing. The internal module unit is electrically activatable, i.e. its function relates to electrical energy which is supplied to the internal module unit. For activation purposes, it is possible to apply a current and/or a voltage to the internal module unit. Although embodiments are conceivable in which the internal module unit has its own power supply, for example in the form of a battery, that has a connecting plug via which it can be connected to an external power source. Furthermore, the internal module has at least one inner connector part. This could also be referred to simply as an inner connector. Also, the at least one inner connector part is used both for producing a mechanical connection and an electrical connection. Although the inner connector part and the internal module body are mentioned here individually, embodiments are also conceivable in which there is no clear distinction between these two elements. The inner connector part can be integrated at least in part in the internal module body and can be manufactured therewith in particular at least in part as one piece. By way of example, non-conductive areas of the inner connector part can be manufactured as one piece with a part of the above-mentioned housing of the internal module body. The inner connector part may be rigidly connected to the internal module body.

Each inner connector part together with an emblem connector part forms a connector pair, i.e. these connector parts are coordinated with one another with respect to shape and position so that they can be plugged together. Due to their design and arrangement on the respective module body, the connector parts can define a plug-in axis along which the modules must be moved toward each other in order to connect them. At least one connector part protrudes from the associated module body. In the assembled state, the connector part protrudes in the direction of the respective other module. In the case of the emblem module, the emblem connector part protrudes inward in the direction of the internal module. In the case of the internal module, the inner connector part protrudes outward in the direction of the emblem module. As a result, the connector pair can be plugged together through a through-opening in the external paneling element, so that the emblem assembly is secured in a positive-locking manner on the external paneling element and the internal module unit is electrically connected to each functional unit. The external paneling element can have one or more through-openings which connect the inner side to the outer side. By virtue of the fact that at least one connector part protrudes from the module body, it can be or is arranged in a through-opening, whereas the module body is arranged on the inner side or else the outer side. Due to the connector part, it is thus possible to provide a connection to the opposite-lying side of the external paneling element. In the assembled state, the emblem connector part and the inner connector part of a connector pair can be inserted through the one through-opening. In other words, at least one of the connector parts, possibly also both, protrudes into the through-opening, which makes it possible to plug them together. The connection of the two connector parts can be performed in a non-positive and/or positive-locking manner. In each case, the two modules are mechanically connected by being plugged together.

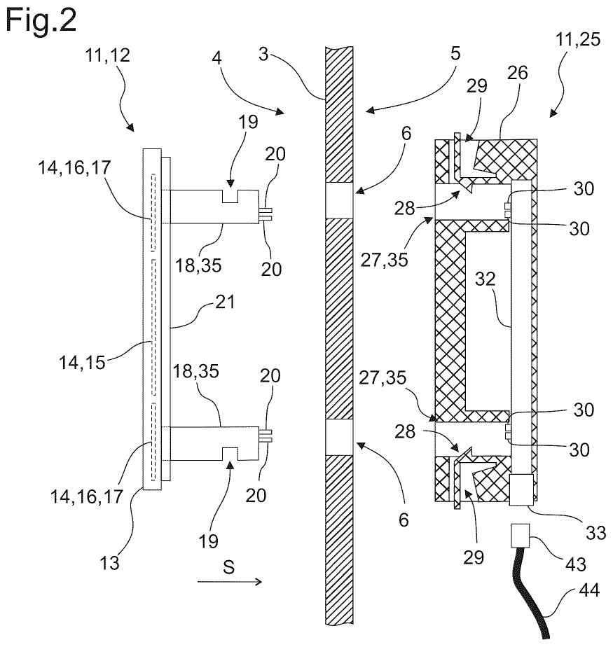

Due to the connector parts being connected, a connection between the emblem module and the internal module is produced through the at least one through-opening. On the one hand, this secures the emblem assembly to the external paneling element in a positive-locking manner. As long as the plug-in connection is in place, the emblem assembly cannot be pulled outward, since this is prevented by a positive-locking connection between the internal module body and the external paneling element. Also, it cannot be pulled inward, since this is prevented by a positive-locking connection between the emblem module body and the external paneling element. Also, it cannot be pushed in the direction of a plane of the external paneling element (i.e., generally in and out of the page, relative to, say FIG. 2), since this is prevented by a positive-locking connection between the connector pair and the external paneling element in the region of the through-opening. It is to be noted that the positive-locking connection between the emblem assembly and the external paneling element can be supplemented by further measures. By way of example, the emblem module body can have a self-adhesive coating on the inside, which creates a material connection to the external paneling element. Such a coating can also help to seal the through-opening. The internal module body can also be connected to the external paneling element by additional measures, by way of example by a latching connection, by a screw connection, a clip connection etc.

Apart from the mechanical connection between the two modules, the internal module unit is electrically connected to each functional unit by the connection of at least one connector pair. The electrical connection can be designed in particular in such a manner that at least one functional unit can be activated via the internal module unit. In other words, the electrical energy supply of the functional unit can be provided via the internal module unit. In an example, the internal module unit is connected to the at least one functional unit for signal transmission. In other words, analog and/or digital electrical signals can be transmitted via the at least one connector pair. Transmission can occur from the internal module unit to the functional unit and/or conversely. Overall, due to the electrical connection, the internal module unit and the at least one functional unit can be regarded effectively as cooperating parts of an electrical assembly, which is arranged in part on the inside and in part on the outside of the external paneling element.

Overall, the structure of the emblem assembly in accordance with the disclosure enables an advantageous design of the outer-lying emblem module body. Since parts of the above-mentioned electrical assembly are in part arranged on the inside of the internal module unit, the functional unit can be designed to be correspondingly small and space-saving. The size of the emblem module can therefore correspond somewhat to that of a conventional emblem. Particularly sensitive components can also be arranged on the inner side. The at least one connector pair can have a comparatively small cross section, which is why a relatively small through-opening is sufficient. The necessary intervention in the structure of the external paneling element is therefore minimal. It is even possible to use a through-opening that is used in other versions of the motor vehicle to attach a conventional emblem. Different designs could thus be achieved with an external paneling element. It would even be conceivable to retrofit the emblem assembly in lieu of a conventional emblem.

In an example, the internal module unit is configured for the control and/or signal processing of at least one functional unit. In the first case, the internal module unit is configured so as to control and/or actuate the relevant functional unit. In particular, it can generate control signals for this functional unit and transmit them via the at least one connector pair. The control signals can be digital or analog signals. In each case, they influence the functional unit, for example by activating or deactivating it or changing the type of activity. Setting a specific voltage or a specific current to operate the functional unit can also be considered as the control. In the second case, the internal module unit is configured so as to receive and to process signals from the functional unit. Processing may include evaluation, but it may also involve preparation or conversion of the signal, for example filtering of certain frequencies, analog-to-digital conversion, amplification, or the like. In each case, functions which are closely connected to the operation of the functional unit can be transferred to the internal module. It is thus possible to keep the volume of the emblem module small. In addition, possibly sensitive electrical components that are necessary for the control or signal processing can be better protected from environmental influences and interference on the inner side of the external paneling element.

Embodiments are conceivable in which only a single connector pair is provided. However, in an example, the emblem assembly has a plurality of connector pairs. The connector pairs may be spaced apart from one another. Likewise, in an example, each connector pair is allocated a dedicated through-opening. In an example, the emblem module is connected in a non-rotatable manner to the external paneling part. This also applies if the individual through-opening has only a small cross section, which can be the case in particular if it can also be used alternatively for attaching a conventional emblem.

Signal transmission between the internal module unit and the functional unit is also possible in principle via an inductive and/or capacitive coupling. However, the connector parts of at least one connector pair may have electrical contacts via which the internal module unit and the functional unit can be conductively connected. The respective connector part can, for example, have a non-conductive insulation which partially shields the respective contact. In addition, the non-conductive part of the connector part can produce at least in part the mechanical connection to the other connector part. The non-conductive part can also mechanically stabilize the contact and/or a line connected to it. The electrical contacts of the two connector parts contact one another if the connector parts are plugged together and thus produce a conductive connection. A connector part can have one or more contacts. It is understood that the number of contacts in the connector parts of a connector pair should match.

The mechanical connection between the connector parts of a connector pair could be based solely on a non-positive connection, such that the connector parts are pressed together and then held together by friction. Advantageously, the connector parts are, however, at least also connected in a positive-locking manner. In accordance with an embodiment, at least one connector part has an elastically deflectable latching element which engages in a recess on the other connector part of the connector pair in order to prevent the connector pair from becoming disconnected unintentionally. The latching element can have a profile that is beveled on one side relative to the plug-in axis, so that it is deflected sideways when plugged together. When the latching element reaches the recess on the other connector part, it returns to its original position and thus locks into place, which is in particular also acoustically perceptible. The profile on the opposite side runs perpendicular to the plug-in axis so that the latching connection cannot be released by a pulling force. For releasing, the latching element can have a release section, to which pressure can be applied, for example, using a suitable tool, in order to deliberately release the latching element. In order to keep the emblem connector part as small as possible and structurally simple, the inner connector part can have the latching element, whereas the recess is formed on the emblem connector part. However, the reverse arrangement is also possible. Both the latching element and also the part of the other connector part which defines the recess are made of a non-conductive material such as a synthetic material.

At least one emblem connector part protrudes from the emblem module body and in the assembled state protrudes through a through-opening. The emblem connector part therefore extends from the outer side up to the inner side of the external paneling element. Accordingly, the associated inner connector part can be arranged fully on the inside of the external paneling element or, where necessary, protrude into the through-opening but not through it. In other words, once the internal module is assembled, it does not protrude outward. This means that even if the emblem module is missing, it can hardly be accidentally damaged, for example if the emblem module has not yet been installed during the initial assembly or if the emblem module needs to be replaced. However, it is possible in the case of this embodiment that the inner connector part also protrudes from the internal module body, albeit to a lesser extent.

Various types of functional units are conceivable. A functional unit can, for example, have at least one light element which is configured so as to illuminate the emblem module at least in sections. In this case, the functional unit can also be referred to as a lighting unit. The light element can be designed in particular as an LED. It is also possible to provide a plurality of light elements (in particular LEDs) for different colors. The internal module unit can actuate the at least one light element, i.e. switch it on and off, for example. The internal module unit can also selectively activate different light elements in order to achieve an illumination in different colors. It is understood that reflecting elements and/or light-conducting elements can also be provided in addition to the light element. The illumination of the emblem module may consist in, in particular, that the light element backlights or transilluminates at least a translucent or even transparent part of the emblem module body.

A functional unit is also designed as a sensor unit which can be triggered by a body part of a user. The body part of the user can be in particular a hand or a part of a hand. The sensor unit can be triggered by pressing it, touching it without applying pressure, or approaching it. For example, the sensor unit could be designed as a pressure switch. A signal from the sensor unit can be received and processed by the internal module unit. The internal module unit can then send another signal to a higher-level control unit in the motor vehicle. Alternatively, the signal from the sensor unit can also be forwarded to the aforementioned control unit without further processing. The control unit can be regarded as part of the vehicle system.

The internal module unit or the control unit can also deactivate the sensor unit so that detection is temporarily impossible. In particular, the sensor unit could only be triggered if the proximity of a transponder to the vehicle had been detected beforehand. Such a transponder can be carried by the authorized user and is detected by the vehicle. After the transponder has been detected, a change in illumination can also indicate that the sensor unit is now ready for use. For example, an above-mentioned lighting element can be switched on as soon as the transponder has been detected. The color of the illumination can be changed if the sensor unit has been activated or if an unsuccessful attempt to trigger it has been made. For example, the color could change from white to red if the user has attempted to activate the sensor unit but the signal received by the sensor is not clear. Another color change would be, for example, from white to blue, if the triggering was successful. Other illumination variants and changes is conceivable.

One embodiment provides that the sensor unit is designed as a capacitive sensor. The sensor unit can have one or more electrodes which can be integrated into the emblem module body. Applying a voltage generates an electric field that is influenced by the presence of an object or body part in the vicinity of the at least one electrode. This in turn influences the capacity of the sensor unit and its impedance. The applied voltage, which can be either DC or AC, can be controlled by the internal module unit. Furthermore, the internal module unit can measure the flowing current and thus detect the approach of or contact with a body part. However, the evaluation can also be performed in the above-mentioned higher-level control unit. In lieu of a specific voltage, it is also possible to set a specific current, wherein the resulting voltage is measured in order to establish changes in impedance.

A closure element of the motor vehicle, in particular a cargo compartment lid, can be unlocked by triggering the sensor unit. In this context, a closure element is any element that closes an opening of the motor vehicle when in the closed position and releases the opening when in the open position. This can be, for example, a vehicle door, a hood or a flap covering a fuel cap or charging socket. In particular, it could be the cargo compartment lid, wherein this term refers to all closure elements that close a cargo compartment or luggage compartment. In other words, the cargo compartment lid can be pivoted about a horizontal axis or about a vertical axis or can be displaced in another manner. It can optionally have at least one window. The closure element can be locked or unlocked as desired. In other words, a locking mechanism is allocated to the closure element which when in the locked state prevents opening. The locking mechanism can also be regarded as part of the vehicle system. If the sensor unit is activated, the corresponding signal can be processed in the internal module unit and/or in the control unit, whereupon, for example, the control unit can unlock the closure element. A user can then open the closure element. The cargo compartment lid has the external paneling element on which the emblem assembly is arranged. Since conventional emblems are also often located on the cargo compartment lid, it makes sense to place an emblem with a sensor unit there, wherein this sensor unit can be used to unlock the cargo compartment lid. This arrangement is intuitive and ergonomically easy to use for the user.

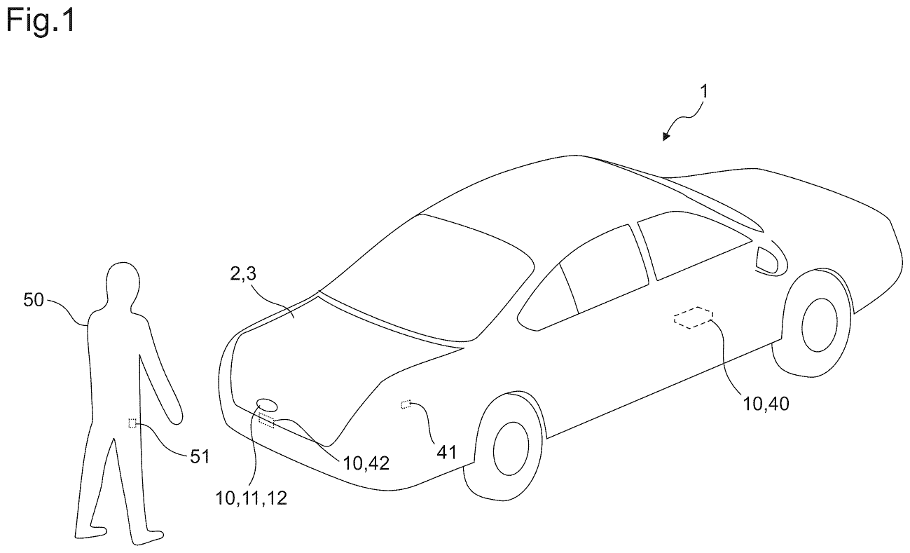

FIG. 1 shows a motor vehicle 1, in this case a passenger car. The motor vehicle has a cargo compartment lid 2, which forms a closure element for a cargo compartment (not visible in FIG. 1). The cargo compartment lid is secured by a locking mechanism 42. This is connected to a control unit 40 of the motor vehicle 1. The control unit 40 is also connected to an antenna 41, the function of which is explained below. An emblem assembly 11 is arranged on the cargo compartment lid 2 and one emblem module 12 of the emblem assembly is visible in FIG. 1. The emblem assembly 11, the control unit 40 and the locking mechanism 42 belong to a vehicle system 10 in accordance with this disclosure.

FIG. 2 shows a first phase of the assembly process. On the one hand, the emblem module 12 can be seen, which is arranged on an outer side 4 of an external paneling element 3. The outer side 4 forms the outer skin of the cargo compartment lid 2. On the other hand, an internal module 25 is shown which is also part of the emblem assembly 11. This internal module 25 is arranged on the inner side 5 of the external paneling element 3. FIG. 2 shows the two modules 12, 25 still at a distance from the external paneling element 3. The emblem module 12 has an emblem module body 13, which is relatively flat and bears an emblem (not visible) on a side facing away from the external paneling element 3. Furthermore, two functional units 14 are arranged in the inside of the emblem module body 13. On the one hand, this is a sensor unit 15 which is designed as a capacitive sensor, and on the other hand, a lighting unit 16 which has a plurality of light elements 17, which can be LEDs, for example OLEDs. Two emblem connector parts 18 protrude from the emblem module body 13 and may be produced in part as one piece with the emblem module body 13 from non-conductive material such as a synthetic material. Each emblem connector part 18 is allocated a through-opening 6 in the external paneling element 3. The orientation of the emblem connector parts 18 and that of the through-openings 6 which are centered along plug-in axes parallel to direction S in FIGS. 2-4. At the end, the emblem connector parts 18 have a plurality of emblem contacts 20, which are conductively connected to the functional units 14. Transverse to the direction S, a recess 19 is formed on the side of each emblem connector part 18. A self-adhesive rubber coating 21 is arranged on the emblem module body 13 on a side facing the external paneling element 3.

The internal module 25 has an internal module body 26, which can be made of synthetic material. An internal module unit 32 is arranged within the internal module body 26 and has a connecting plug 33. The connecting plug 33 is matched to a cable connector 43, which is arranged on a cable 44. The cable 44 may, for example, be a bus line via which the internal module unit 32 can be connected to other systems of the motor vehicle 1, in particular to the control unit 40, i.e. the central control unit (CPU). Furthermore, two inner connector parts 27 are formed on the internal module body 26 and they each define recesses the size and shape of which are matched to the emblem connector parts 18. Furthermore, internal contacts 30 of each inner connector part 18 are connected to the internal module unit 32. These are matched to the above-mentioned emblem contacts 20. Consequently, each emblem connector part 18 forms a connector pair 35 with a respective inner connector part 27. An elastically deflectable latching element 28 is arranged on each inner connector part 27 and is produced as one piece with the internal module body 26. A deflecting section 29 is connected to each latching element 28.

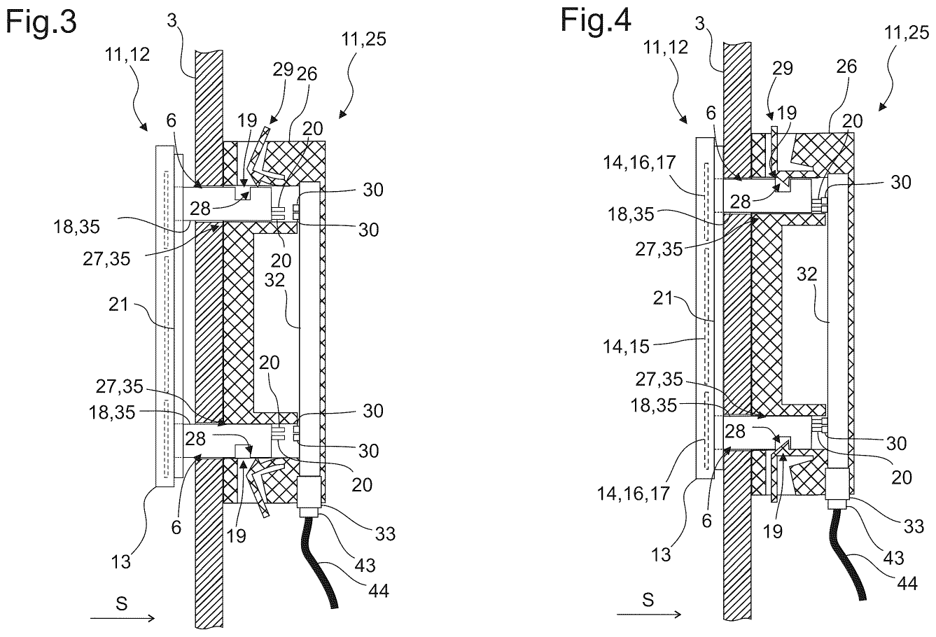

FIG. 3 shows a state in which the connecting plug 33 and connector 43 have been connected to one another and the internal module 25 having the internal module body 26 has been positioned on the external paneling element 3 in such a manner that the positions of the inner connector parts 27 match the positions of the through-openings 6. Optionally, connecting means could be provided in order to attach the internal module 25 in the illustrated position. The emblem connector parts 18 have been inserted in the direction of the plug-in axes through the through-openings 6 and inserted in part into the inner connector parts 27, as a result of which the latching elements 28 have been deflected transversely relative to the direction S. The emblem contacts 20 and the internal contacts 30 are still separated from one another. FIG. 4 shows the finished assembled state in which the contacts 20, 30 are in contact with one another, as a result of which a conductive connection is produced between the internal module unit 32 and the functional units 14. The rubber coating 21 is in contact with the external paneling element 3, as a result of which an adhesive bond is produced between the emblem module 12 and the external paneling element 3. Each latching element 28 engages in a recess 19, as a result of which a positive-locking connection is achieved in the direction S. In the event that this is released, the respective latching element 28 can be deflected via the deflecting section 29, after which the two modules 12, 25 can be separated from one another.

The emblem assembly 11 can be used as part of the vehicle system 10 to unlock the cargo compartment lid 2. In a first step, the control unit 40 can use the antenna 41 to detect the approach of a user 50 who is carrying a transponder 51. The latter can be, for example, integrated in a car key. Due to the approach of the user 50, the control unit 40 activates (optionally in addition to other light elements not shown) at least one light element 17 of the lighting unit 16. This provides the user 50 with visual feedback that their presence has been detected and also draws their eye to the emblem module 12. The actual control of the lighting unit 16, for example the setting of a suitable current for the respective light element 17, can be carried out within the internal module unit 32. After detecting the user 50, the internal module unit 32 can also activate the sensor unit 15 so that the latter generates a detection field (not shown here). If the hand of the user 50 now approaches the sensor unit 15, a change in the capacity and/or the impedance of the sensor unit 15 can be detected by the internal module unit 32. After appropriate evaluation of the signal, the internal module unit 32 can contact the control unit 40 via the cable 44, whereupon the control unit can release the locking mechanism 42. At the same time, if the hand of the user 50 is successfully detected, the internal module unit 32 could control the lighting unit 16 in such a manner that the lighting color changes.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An emblem assembly, comprising:
an emblem module configured to be arranged on an outside of an external paneling element of a motor vehicle, wherein the emblem module includes at least one electrically activatable functional unit and at least one emblem connector; and
an internal module configured to be arranged on an inside of the external paneling element, wherein the internal module includes an electrically activatable internal module unit and at least one inner connector, wherein the at least one inner connector and the at least one emblem connector form a connector pair, wherein at least a portion of the connector pair is configured extend through a through-opening in the external paneling element such that the emblem assembly is securable on the external paneling element and the internal module unit is electrically connectable to the at least one functional unit.

2. The emblem assembly according to claim 1, wherein the internal module unit is configured for control of the at least one functional unit.

3. The emblem assembly according to claim 1, wherein the internal module unit is configured for signal processing of the at least one functional unit.

4. The emblem assembly according to claim 1, further comprising at least one additional connector pair.

5. The emblem assembly according to claim 1, wherein the at least one emblem connector and the at least one inner connector of the connector pair have electrical contacts via which the internal module unit and the at least one functional unit are conductively connectable.

6. The emblem assembly according to claim 1, wherein one of the at least one emblem connector and the at least one inner connector has an elastically deflectable latching element which engages in a recess on the other of the at least one emblem connector and the at least one inner connector.

7. The emblem assembly according to claim 1, wherein the at least one emblem connector protrudes from the emblem module and is configured to protrude through the through-opening.

8. The emblem assembly according to claim 1, wherein the at least one functional unit has at least one light element configured to at least partially illuminate the emblem module.

9. The emblem assembly according to claim 1, wherein the at least one functional unit is a sensor unit triggerable by a user.

10. The emblem assembly according to claim 9, wherein the sensor unit is a capacitive sensor.

11. A motor vehicle, comprising:
an external paneling element; and
an emblem assembly comprising:
an emblem module having an emblem module body arranged on an outside of the external paneling element, at least one electrically activatable functional unit, and at least one emblem connector; and
an internal module having an internal module body arranged on an inside of the external paneling element, an electrically activatable internal module unit, and at least one inner connector which together with the at least one emblem connector forms a connector pair,
wherein at least one connector of the connector pair protrudes from an associated one of the emblem module body and the internal module body,
wherein the connector pair is plugged together through a through-opening in the external paneling element such that the emblem assembly is secured on the external paneling element and the internal module unit is electrically connected to the at least one functional unit.

12. The motor vehicle according to claim 11, wherein the at least one functional unit has at least one light element configured to at least partially illuminate the emblem module.

13. The motor vehicle according to claim 11, wherein the at least one functional unit is a sensor unit triggerable by a body part of a user.

14. The motor vehicle according to claim 13, wherein the sensor unit is a capacitive sensor.

15. The motor vehicle according to claim 13, further comprising a closure element, wherein the closure element is unlockable by triggering the sensor unit.

16. The motor vehicle according to claim 15, wherein the closure element is a cargo compartment lid.

17. A method, comprising:
plugging a connector pair of an emblem assembly together through a through-opening in an external paneling element of a motor vehicle, wherein the connector pair includes at least one emblem connector of an emblem module and at least one inner connector of an internal module, wherein the plugging is such that the emblem assembly is secured in a positive-locking manner on the external paneling element and an electrically activatable internal module unit of the internal module is electrically connected to at least one electrically activatable functional unit of the emblem module.

18. The method according to claim 17, further comprising: controlling at least one light element to illuminate the emblem module at least in sections.

19. The method according to claim 17, further comprising: detecting, via a sensor unit, a body part of a user in proximity to the emblem module.

20. The method according to claim 19, further comprising: unlocking a closure element of the motor vehicle in response to detecting the body part of the user.
